(19) United States
(12) Patent Application Publication
(10) Pub. No.: US 2024/0367538 A1
(43) Pub. Date: Nov. 7, 2024

(54) THERMOSTAT CONTROLLED SWITCHING FOR ELECTRIC UNIT HEATERS

(71) Applicant: Modine Manufacturing Company, Racine, WI (US)

(72) Inventor: Jacob M. Pachniak, Racine, WI (US)

(21) Appl. No.: 18/310,713

(22) Filed: May 2, 2023

(51) Int. Cl. B60L 53/62; F24H 3/00

(52) U.S. Cl. CPC B60L 53/62; F24H 3/002; F24H 15/254; F24H 15/269

(57) ABSTRACT

A system for charging an electric vehicle and heating a space. The system includes an electric heater and a thermostat. The thermostat includes a temperature sensor, a first electrical outlet, a second electrical outlet, a first circuit, a second circuit, and an electronic controller. The electronic controller receives, via the temperature sensor, a signal, determines a temperature value, and determines whether the temperature value is greater than a temperature threshold. In response to determining the temperature value is greater than the temperature threshold, the electronic controller supplies power to the first circuit and controls the first circuit to supply a charging current to the electric vehicle via the first electrical outlet. In response to determining the temperature value is less than the temperature threshold, the electronic controller supplies power to the second circuit and controls the second circuit to supply power to the electric heater via the second electrical outlet.

### FIELD OF THE INVENTION

The present invention relates to thermostat controlled switching for electric unit heaters.

### SUMMARY

Electric vehicle batteries and chargers may experience slow charging in cold temperature conditions. Charging electric vehicle batteries in warm temperature conditions may provide improved charging efficiency and battery charging and discharging performance. Electric vehicle battery charging is often performed in an environment with the presence of a heat source. In some instances, it may be difficult to balance maintaining a temperature of the environment and charging the electric vehicle battery at a charging efficiency or a charging time of the electric vehicle battery.

The disclosure provides, in one aspect, a system for charging an electric vehicle and heating a space. The system includes an electric heater to heat the space and a thermostat. The thermostat includes a temperature sensor that senses a temperature of a surrounding environment, a first electrical outlet that connects to the electric vehicle, a second electrical outlet that connects to the electric heater, a first circuit in communication with the first electrical outlet, a second circuit in communication with the second electrical outlet, and an electronic controller in communication with the temperature sensor, the first circuit, and the second circuit. The electronic controller receives, via the temperature sensor, a signal, determines, based on the signal, a temperature value, and determines whether the temperature value is greater than a temperature threshold. In response to determining that the temperature value is greater than the temperature threshold, the electronic controller supplies power to the first circuit and controls the first circuit to supply a charging current to the electric vehicle via the first electrical outlet. In response to determining that the temperature value is less than the temperature threshold, the electronic controller supplies power to the second circuit and controls the second circuit to supply power to the electric heater via the second electrical outlet.

The disclosure provides, in another aspect, a thermostat including a temperature sensor that senses a temperature of a surrounding environment, a first electrical outlet that connects to an electric vehicle, a second electrical outlet that connects to an electric heater, a first circuit in communication with the first electrical outlet, a second circuit in communication with the second electrical outlet, and an electronic controller in communication with the temperature sensor, the first circuit, and the second circuit. The electronic controller receives, via the temperature sensor, a signal, determines, based on the signal, a temperature value, and determines whether the temperature value is greater than a temperature threshold. In response to determining that the temperature value is greater than the temperature threshold, the electronic controller supplies power to the first circuit and controls the first circuit to supply a charging current to the first electrical outlet. In response to determining that the temperature value is less than the temperature threshold, the electronic controller supplies power to the second circuit and controls the second circuit to supply power to the second electrical outlet.

The disclosure provides, in another aspect, a method for switching between charging an electric vehicle and heating a space. The method includes receiving, via an electronic controller, a signal from a temperature sensor, determining, via the electronic controller, a temperature value based on the signal, and determining, via the electronic controller, whether the temperature value is greater than a temperature threshold. The method also includes, in response to determining that the temperature value is greater than the temperature threshold, supplying power to the first circuit and controlling the first circuit to supply a charging current to the electric vehicle via a first electrical outlet. The method also includes, in response to determining that the temperature value is less than the temperature threshold, supplying power to the second circuit and controlling the second circuit to supply power to the electric heater via a second electrical outlet.

The disclosure provides, in another aspect, a system for charging an electric vehicle and heating a space. The system including an electric heater to heat the space and a thermostat secured to a wall of the space. The thermostat includes a temperature sensor that senses a temperature of a surrounding environment, a first electrical cord that connects to the electric vehicle, a second electrical cord that connects to the electric heater, a first circuit in communication with the first electrical cord, a second circuit in communication with the second electrical cord, and an electronic controller in communication with the temperature sensor, the first circuit, and the second circuit. The electronic controller receives, via the temperature sensor, a signal, determines, based on the signal, a temperature value, and determines whether the temperature value is greater than a temperature threshold. In response to determining that the temperature value is greater than the temperature threshold, the electronic controller supplies power to the first circuit and controls the first circuit to supply a charging current to the electric vehicle via the first electrical cord. In response to determining that the temperature value is less than the temperature threshold, the electronic controller supplies power to the second circuit and controls the second circuit to supply power to the electric heater via the second electrical cord.

Other aspects of the invention will become apparent by consideration of the detailed description and accompanying drawings.

### BRIEF DESCRIPTION OF THE DRAWINGS

FIG. 1 illustrates a system including a thermostat, an electric vehicle, and an electric heater, according to some embodiments.

FIG. 2 illustrates a thermostat, according to some embodiments.

FIG. 3 illustrates a thermostat, according to some embodiments.

FIG. 4 is a block diagram of a system including a thermostat, according to some embodiments.

FIG. 5 is a flow chart of a method for switching between charging an electric vehicle and heating a space, according to some embodiments.

### DETAILED DESCRIPTION OF THE DRAWINGS

Before any embodiments of the invention are explained in detail, it is to be understood that the invention is not limited in its application to the details of construction and the arrangement of components set forth in the following description or illustrated in the accompanying drawings. The invention is capable of other embodiments and of being practiced or of being carried out in various ways.

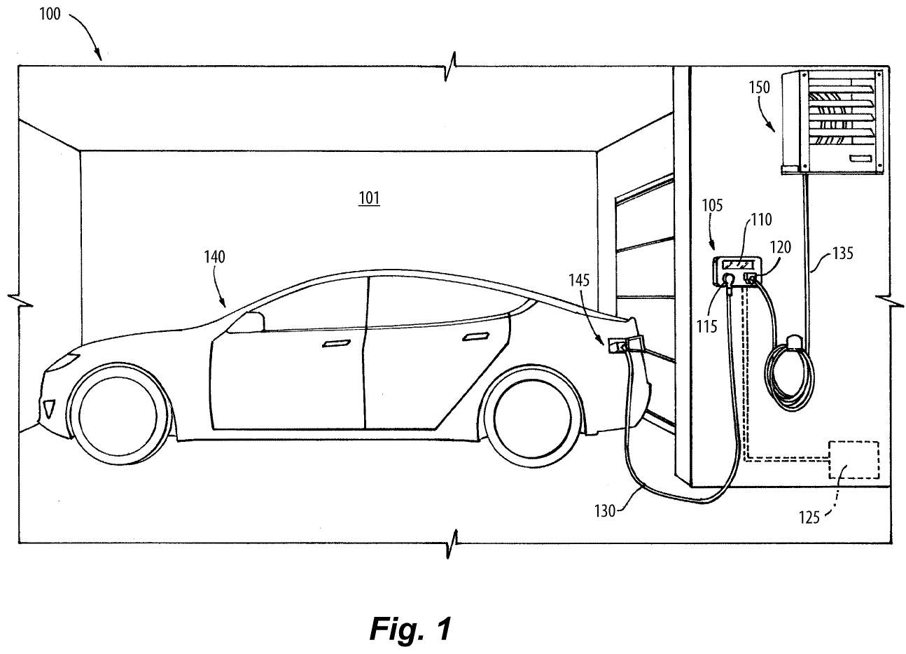

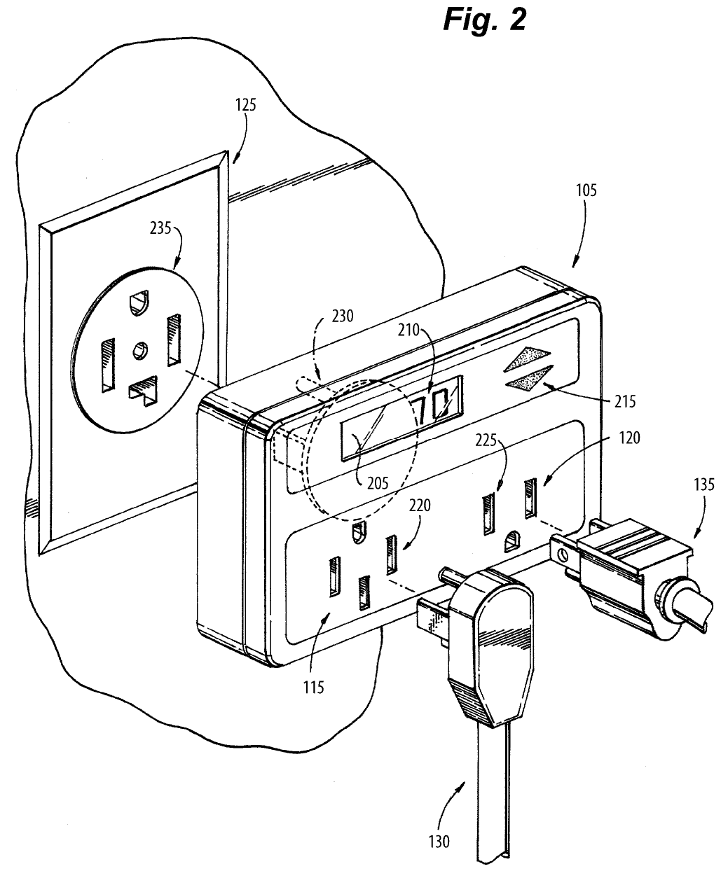

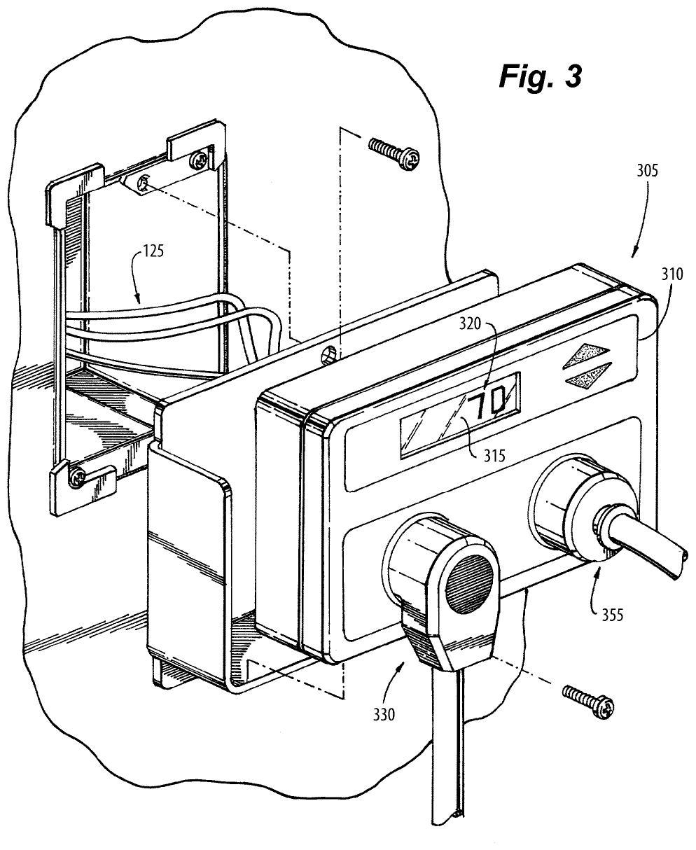

FIG. 1 illustrates a system 100 including a thermostat 105, an electric vehicle 140, and an electric heater 150, according to some embodiments. In the illustrated embodiment, the thermostat 105, the electric vehicle 140, and the electric heater 150 are positioned within a space 101. The space 101 may be a garage, a warehouse, an industrial building, or any suitable enclosed area. In some embodiments, the thermostat 105 includes a user interface 110, a first electrical outlet 115, and a second electrical outlet 120. The user interface 110 may provide an indication to a user and receive a plurality of user inputs (further described below in reference to FIGS. 2-3). The first electrical outlet 115 is configured to electrically connect to the electric vehicle 140 via a first cord 130. For example, a first end of the first cord 130 is coupled to the first electrical outlet 115 and a second end of the first cord 130 is coupled to a vehicle charger input 145 of the electric vehicle 140. The first electrical outlet 115 is configured to provide a charging current to the vehicle charger input 145 via the first cord 130 to charge the electric vehicle 140.

The second electrical outlet 120 is configured to electrically connect to the electric heater 150 via a second cord 135. In some embodiments, the second electrical outlet 120 is different than the first electrical outlet 115. Likewise, the second electrical cord 135 may be different than the first electrical cord 130. For example, a first end of the second cord 135 is coupled to the second electrical outlet 120 and a second end of the second cord 135 is coupled to the electric heater 150. The second electrical outlet 120 is configured to provide operational power to the electric heater 150 via the second cord 135. The thermostat 105 is electrically connected to a power source 125. The power source 125 provides operational power to the components of the thermostat 105. In the illustrated embodiment, the power source 125 includes a 30 Ampere (A) or 50 A circuit configured to provide 240 Volts (V) to the thermostat 105. However, other supply voltage values have been contemplated. The electric vehicle 140 is illustrated as a four-wheeled vehicle, but aspects, features, and embodiments described may be applied to other types and designs of wheeled vehicles. The electric heater 150 is configured to heat the space 101. In some embodiments, the electric heater 150 is mounted at a location within the space 101. The electric heater 150 includes heating components that provide heat to the space 101 when the electric heater 150 receives operational power from the second electrical outlet 120.

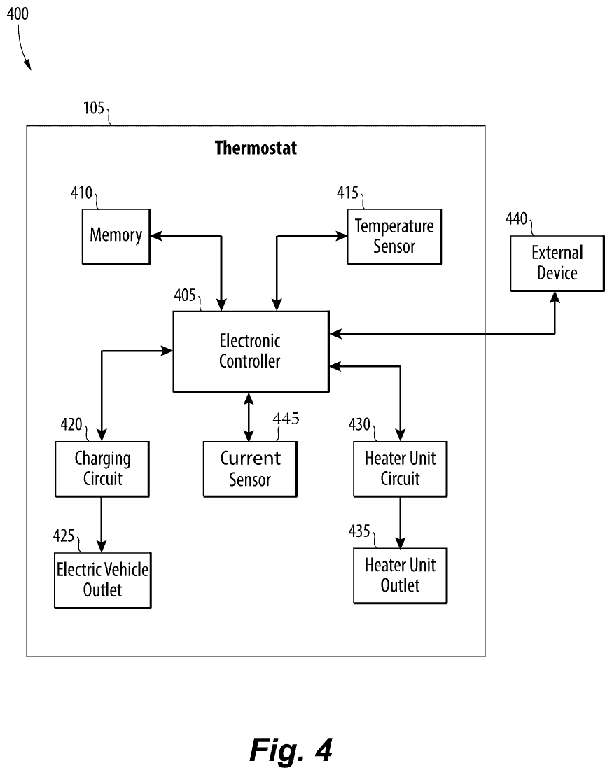

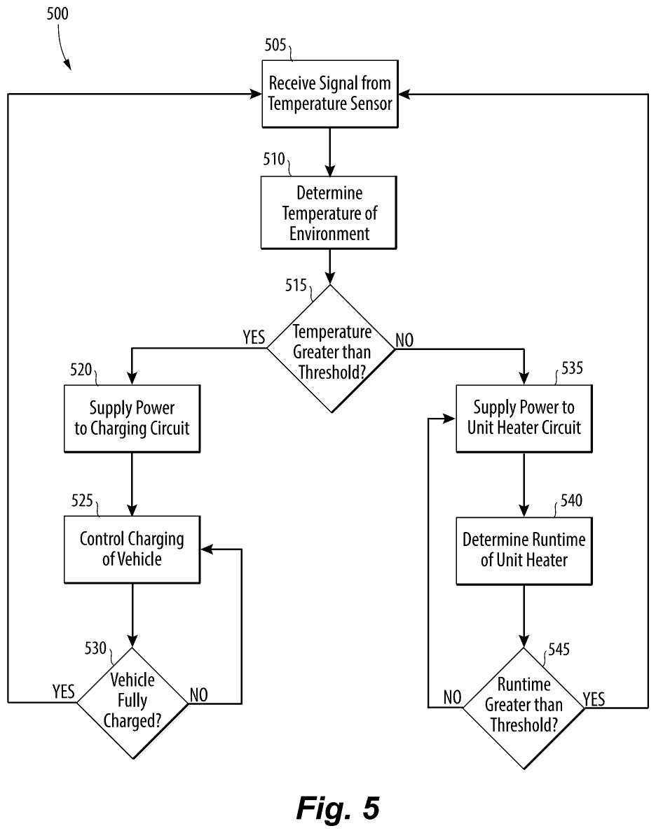

FIG. 2 illustrates the thermostat 105, according to some embodiments. The thermostat 105 includes the user interface 110, the first electrical outlet 115, and the second electrical outlet 120. In the illustrated embodiment, the user interface 110 includes a display 205. In some embodiments, the display 205 provides an indication of a temperature value 210 (further described below in reference to FIGS. 4-5) to a user. The user interface 110 may include a plurality of buttons 215. The user interface 110 is configured to receive a plurality of user inputs via the plurality of buttons 215.

The first electrical outlet 115 includes a first electrical receptacle 220. The first electrical receptacle 220 is configured to receive the first cord 130. For example, the first electrical receptacle 220 mechanically and/or electrically couples the first cord 130 to the first electrical outlet 115. The second electrical outlet 120 includes a second electrical receptacle 225. The second electrical receptacle 225 is configured to receive the second cord 135. For example, the second electrical receptacle 225 mechanically and/or electrically couples the second cord 135 to the second electrical outlet 120. In some embodiments, the second electrical receptacle 225 is different than the first electrical receptacle 220.

In the illustrated embodiment, the thermostat 105 includes a plug 230. The plug 230 is configured to electrically connect to a third electrical receptacle 235 of the power source 125. When the plug 230 is electrically connected to the third electrical receptacle 235, the thermostat 105 receives operational power from the power source 125. The third electrical receptacle 235 is preferably a 240 V outlet.

FIG. 3 illustrates a thermostat 305, according to some embodiments. The thermostat 305 includes similar components to the thermostat 105 described above. The thermostat 305 may be an alternative embodiment to the thermostat 105. For example, the thermostat 305 includes integrated components. The thermostat 305 may be integrated into a wall of the space 101. When the thermostat 305 is integrated into the wall of the space 101, the thermostat 305 is directly connected (e.g., hard-wired) to the power source 125. The thermostat 305 includes a user interface 310, a display 315 configured to provide an indication of a temperature value 320, and a plurality of buttons 325. The user interface 310, the display 315, and the plurality of buttons 325 may include similar components, and perform similar functions, to the user interface 110, the display 205, and the plurality of buttons 215.

In the illustrated embodiment, the thermostat 305 includes a first outlet 330 and a second outlet 335. The first outlet 330 and the second outlet 335 are integrated (e.g., hard-wired) with the thermostat 305. For example, the first outlet 330 and the second outlet 335 each include an electrical outlet in combination with an electrical cord integrated with the thermostat 305. The first outlet 330 includes a first electrical cord configured to connect to the electric vehicle 140. The second outlet 335 includes a second electrical cord configured to connect to the electric heater 150. In other embodiments, some components of the thermostat 305 may be separate from the thermostat 305. In some instances, the thermostat 305 may be a remotely-mounted thermostat integrated into the wall of the space 101. In such instances, the first outlet 330 and the second outlet 335 are included on a separate device that is in electronic communication with the thermostat 305.

FIG. 4 is a block diagram of a system 400 including the thermostat 105 and an external device 440, according to some embodiments. Although described in reference to the thermostat 105, in some embodiments, the thermostat 305 includes similar components to the thermostat 105 as described below. The thermostat 105 includes, among other things, an electronic controller 405, a memory 410, a temperature sensor 415, a first circuit 420 (e.g., a charging circuit), a first electrical outlet 425 (e.g., an electric vehicle outlet), a second circuit 430 (e.g., a heater unit circuit), an second electrical outlet 435 (e.g., a heater unit outlet), and a current sensor 445. In some embodiments, the memory 410 is included within the electronic controller 405.

The electronic controller 405 is electronically connected to (e.g., in communication with) the memory 410, the temperature sensor 415, the first circuit 420, the second circuit 430, the external device 440, and the current sensor 445. In some embodiments, the electronic controller 405 provides one or more control signals to the first circuit 420 and the second circuit 430. The electronic controller 405 includes a plurality of electrical and electronic components that provide power, operational control, and protection to the components and modules within the electronic controller 405 and/or the thermostat 105. For example, the electronic controller 405 includes, among other things, an electronic processor (e.g., a programmable electronic microprocessor, a microcontroller, or another suitable programmable device). In some embodiments, the electronic controller 405 is implemented partially or entirely on a semiconductor (e.g., a field-programmable gate array [“FPGA” ] semiconductor, an application specific integrated circuit [“ASIC” ], or other programmable semiconductor devices as appropriate for a given application) chip, such as a chip developed through a register transfer level (“RTL”) design process. In some embodiments, the electronic controller 405 includes a relay circuit. The relay circuit opens and closes the electronic connections between the electronic controller 405 and the first circuit 420 and the second circuit 430. In some embodiments, the electronic controller 405 supplies operational power to the first circuit 420 or the second circuit 430 based on the position of the relay circuit.

The memory 410 includes, for example, a program storage area and a data storage area. The program storage area and the data storage area can include combinations of different types of memory, such as read-only memory (“ROM”), random access memory (“RAM”) (e.g., dynamic RAM [“DRAM” ], synchronous DRAM [“SDRAM” ], etc.), electrically erasable programmable read-only memory (“EEPROM”), flash memory, a hard disk, an SD card, or other suitable magnetic, optical, physical, or electronic memory devices. The illustrated electronic controller 405 is connected to the memory 410 and executes software instructions that are capable of being stored in a RAM of the memory (e.g., during execution), a ROM of the memory (e.g., on a generally permanent basis), or another non-transitory computer readable medium such as another memory or a disc. Software included in some implementations of the thermostat 105 can be stored in the memory 410 of the electronic controller 405. The software can include, for example, firmware, one or more applications, program data, filters, rules, one or more program modules, and other executable instructions. The electronic controller 405 is configured to retrieve from memory and execute, among other things, instructions related to the control processes and methods described herein. In other constructions, the electronic controller 405 includes additional, fewer, or different components.

The temperature sensor 415 senses a temperature of a surrounding environment (e.g., the space 101). In some embodiments, the temperature sensor 415 transmits a signal indicative of the temperature of the surrounding environment to the electronic controller 405. For example, the temperature sensor 415 is a thermistor, a thermocouple, a resistance temperature detector (RTD), or other suitable temperature sensor. The first circuit 420 receives power from the electronic controller 405 when the electronic connection between the electronic controller 405 and the first circuit 420 is closed. When the electronic connection is closed, the first circuit 420 supplies a charging current to the first electrical outlet 425. For example, the first circuit 420 supplies the charging current at a nominal charging voltage of the electric vehicle 140 via the first electrical outlet 425. The first electrical outlet 425 may include a similar construction to the first electrical outlet 115 or the first outlet 330. The second circuit 430 receives power from the electronic controller 405 when the electronic connection between the electronic controller 405 and the second circuit 430 is closed. When the electronic connection is closed, the second circuit 430 supplies power to the second electrical outlet 435. For example, the second circuit 430 supplies power to the electric heater 150 via the second electrical outlet 435. The second electrical outlet 435 may include a similar construction to the second electrical outlet 120 or the second outlet 335.

The external device 440 may be a mobile device such as, but not limited to, a smartphone, a laptop, a handheld computer, or a tablet. Although shown in the illustrated embodiment as electronically connected to the electronic controller 405, in some embodiments, the external device 440 connects to the electronic controller 405 via a wireless communications module of the thermostat 105. The external device 440 transmits control signals indicative of control parameters to the electronic controller 405. For example, the external device 440 includes a software application stored in an external device memory. The external device 440 executes the software application to receive user inputs indicative of the control parameters from a user. Based on the received user inputs indicative of the control parameters, the external device 440 transmits control signals to the electronic controller 405 indicative of the control parameters. In some embodiments, the control parameters include, but not limited to, a temperature threshold for the space 101, a runtime of the electric heater 150 (e.g., a period of time that the electric heater 150 provides heat to the space 101), and a minimum runtime of the first circuit 420 (e.g., a minimum period of time that the first circuit 420 provides a charging current).

The current sensor 445 senses a first current of the first circuit 420 (e.g., current drawn by the first circuit 420) and a second current of the second circuit 430 (e.g., current drawn by the second circuit 430). In some embodiments, the current sensor 445 transmits a first current signal indicative of the first current and a second current signal indicative of the second current to the electronic controller 405. In some instances, the electronic controller 405 determines the current drawn by the first circuit 420 based on the first current signal. The electronic controller 405 also determines the current drawn by the second circuit 430 based on the second current signal.

FIG. 5 is a flow chart of a method 500 for switching between charging the electric vehicle 140 and heating the space 101 via the electric heater 150, according to some embodiments. Although the method 500 is described herein with reference to the thermostat 105, the method 500 may be executed via the thermostat 305. The order of the steps disclosed in the method 500 could vary. For example, additional steps may be added to the process and not all of the steps may be required, or steps shown in one order may occur in a second order. In one embodiment, the electronic controller 405 is configured to execute the method 500. In other embodiments, the external device 440 is configured to execute the method 500 in combination with the electronic controller 405. The method 500 begins at step 505 when the electronic controller 405 receives a signal via the temperature sensor 415. For example, the electronic controller 405 receives the signal indicative of the temperature of the surrounding environment. The method 500 then proceeds to step 510.

At step 510, the electronic controller 405 determines a temperature of the surrounding environment based on the received signal. For example, the electronic controller 405 determines the temperature value 210 based on the received signal. In some embodiments, the electronic controller 405 transmits a signal indicative of the temperature value 210 to the display 205 and the display 205 provides the indication of the temperature value 210. The method 500 then proceeds to step 515. At step 515, the electronic controller 405 determines whether the temperature value 210 is greater than the temperature threshold. In some embodiments, the electronic controller 405 receives a first user input indicative of the temperature threshold via the plurality of buttons 215 of the user interface 110. The electronic controller 405 determines the temperature threshold based on the first user input. In other embodiments, the electronic controller 405 receives the first user input via the external device 440 and determines the temperature threshold based on the first user input. When the electronic controller 405 determines that the temperature value 210 is greater than the temperature threshold, the method 500 proceeds to step 520.

At step 520, the electronic controller 405 supplies power to the first circuit 420. For example, the relay circuit opens the electronic connection between the electronic controller 405 and the second circuit 430 such that the second circuit 430 does not receive power. The relay circuit closes the electronic connection between the electronic controller 405 and the first circuit 420 such that the first circuit 420 receives power. The method 500 then proceeds to step 525. At step 525, the electronic controller 405 controls charging of the electric vehicle 140. For example, the electronic controller 405 transmits a control command indicative of supplying the charging current to the first circuit 420. The electronic controller 405 controls the first circuit 420 to supply the charging current to the electric vehicle 140 via the first electrical outlet 115 (e.g., the first electrical outlet 425). The method 500 then proceeds to step 530.

At step 530, the electronic controller 405 determines whether the electric vehicle 140 is charged. For example, the electronic controller 405 receives a second user input indicative of the minimum runtime of the first circuit 420 via the external device 440. In some embodiments, the electronic controller 405 includes a clock circuit to determine an elapsed time of operations of the electronic controller 405. The electronic controller 405 compares the minimum runtime of the first circuit 420 to the elapsed time from the beginning of step 520. When the electronic controller 405 determines that the elapsed time from the beginning of step 520 is less than the minimum runtime of the first circuit 420, the electronic controller 405 determines the electric vehicle 140 is not charged and returns to step 525. The minimum runtime of the first circuit 420 allows for the electric vehicle 140 to receive sufficient charge and limits the runtime of the electric heater 150. When the electronic controller 405 determines that the elapsed time from the beginning of step 520 is greater than the minimum runtime of the first circuit 420, the electronic controller 405 determines that the electric vehicle 140 is charged and stops supplying power to the first circuit 420. The method 500 then returns to step 505 to continue receiving signals from the temperature sensor 415.

Returning to step 515, when the electronic controller 405 determines that the temperature value 210 is less than the temperature threshold, the method 500 proceeds to step 535. At step 535, the electronic controller 405 supplies power to the second circuit 430. For example, the relay circuit opens the electronic connection between the electronic controller 405 and the first circuit 420 such that the first circuit 420 does not receive power. The relay circuit closes the electronic connection between the electronic controller 405 and the second circuit 430 such that the second circuit 430 receives power. The electronic controller 405 controls the second circuit 430 to supply power to the electric heater 150 via the second electrical outlet 120 (e.g., the second electrical outlet 435). The second circuit 430 may be prioritized by the electronic controller 405 such that the space 101 is heated to a temperature greater than the temperature threshold. The method 500 then proceeds to step 540. At step 540, the electronic controller 405 determines the runtime of the electric heater 150. For example, the electronic controller 405 receives a third user input indicative of the runtime of the electric heater 150 via the external device 440. The electronic controller 405 determines the runtime of the electric heater 150 based on the third user input. The method 500 then proceeds to step 545.

At step 545, the electronic controller 405 determines whether the runtime of the electric heater 150 is greater than a runtime threshold. For example, the electronic controller 405 compares the runtime of the electric heater 150 to the elapsed time from the beginning of step 535. When the electronic controller 405 determines that the elapsed time from the beginning of step 535 is less than the runtime of the electric heater 150, returns to step 535 to continue supplying power to the electric heater 150. In some embodiments, when the electronic controller 405 determines that the elapsed time from the beginning of step 535 is less than the runtime of the electric heater 150 and the electronic controller 405 determines that the temperature value 210 is greater than the temperature threshold, the electronic controller 405 stops supplying power to the second circuit 430. When the electronic controller 405 determines that the elapsed time from the beginning of step 535 is greater than the runtime of the electric heater 150, the electronic controller 405 stops supplying power to the second circuit 430. The method 500 then returns to step 505 to continue receiving signals from the temperature sensor 415. In some embodiments, when the electronic controller 405 determines that the electric vehicle 140 is charged and the temperature value 210 is greater than the temperature threshold, the relay circuit opens the electronic connections between the electronic controller 405 and the first circuit 420 and the second circuit 430.

In some embodiments, the method 500 switches between charging the electric vehicle 140 and heating the space 101, via the electric heater 150, based on other control parameters in addition to the temperature value 210. For example, at step 505, the electronic controller 405 also receives the first current signal and/or the second current signal from the current sensor 445. At step 510, the electronic controller 405 also determines the current drawn by the first circuit 420 based on the first current signal and/or the current drawn by the second circuit 430 based on the second current signal. When the electronic controller 405 supplies power to the first circuit 420, for example at step 520, and controls charging of the electric vehicle 140, for example at step 525, the electronic controller 405 may set a lower charging rate or ramp down charging (e.g., when the electronic controller 405 determines the current drawn is less than a current threshold) as the electric vehicle 140 charges. Based on the determined current drawn by the first circuit 420 at the lower charging rate, the electronic controller 405 determines that power can also be supplied to the second circuit 430. In some embodiments, the electronic controller 405 closes the electronic connection between the second circuit 430 and the electronic controller 405 while the electronic connection between the first circuit 420 and the electronic controller 405 is also closed. In such embodiments, closing the electronic connection between the second circuit 430 and the electronic controller 405 allows the electronic controller 405 to perform steps 520 and 535 simultaneously. The electronic controller 405 supplies the charging current, uninterrupted, to the first circuit 420 while the electric heater 150 heats the space 101.

As described above, in some embodiments, the method 500 is executed via the thermostat 305. In such embodiments, at step 510, the electronic controller 405 determines the temperature value 320 based on the received signal. The electronic controller 405 transmits a signal indicative of the temperature value 320 to the display 315 and the display 315 provides the indication of the temperature value 320. At step 525, the electronic controller 405 controls the first circuit 420 to supply the charging current to the electric vehicle 140 via the first outlet 330 (e.g., via the first electrical cord of the first outlet 330). At step 535, the electronic controller 405 controls the second circuit 430 to supply power to the electric heater 150 via the second outlet 335 (e.g., via the second electrical cord of the second outlet 335).

Although the invention has been described with reference to certain preferred embodiments, variations and modifications exist within the scope and spirit of one or more independent aspects of the invention as described.

What is claimed is:

1. A system for charging an electric vehicle and heating a space, the system comprising:
an electric heater configured to heat the space; and
a thermostat including
a temperature sensor configured to sense a temperature of a surrounding environment;
a first electrical outlet configured to connect to the electric vehicle;
a second electrical outlet configured to connect to the electric heater;
a first circuit in communication with the first electrical outlet;
a second circuit in communication with the second electrical outlet;
an electronic controller in communication with the temperature sensor, the first circuit, and the second circuit, the electronic controller configured to:
receive, via the temperature sensor, a signal;
determine, based on the signal, a temperature value;
determine whether the temperature value is greater than a temperature threshold;
in response to determining that the temperature value is greater than the temperature threshold:
supply power to the first circuit;
control the first circuit to supply a charging current to the electric vehicle via the first electrical outlet;
in response to determining that the temperature value is less than the temperature threshold:
supply power to the second circuit; and
control the second circuit to supply power to the electric heater via the second electrical outlet.

2. The system of claim 1, wherein the electronic controller is configured to:
determine whether the electric vehicle is charged; and
stop supplying power to the first circuit in response to determining that the electric vehicle is charged.

3. The system of claim 1, wherein the electronic controller is configured to:
determine a runtime of the electric heater;
determine whether the runtime of the electric heater is greater than a runtime threshold; and
stop supplying power to the second circuit in response to determining that the runtime is greater than the runtime threshold.

4. The system of claim 1, wherein the thermostat further includes:
a plug in communication with a power source, the plug configured to receive operational power from the power source.

5. The system of claim 1, wherein the thermostat further includes:
a display configured to provide an indication of the temperature value; and
a user interface configured to receive a plurality of user inputs.

6. The system of claim 5, wherein the electronic controller is configured to:
receive a first user input via the user interface; and
determine the temperature threshold based on the first user input.

7. The system of claim 1, wherein the thermostat further includes:
a current sensor configured to sense a current of the first circuit; and
wherein the electronic controller is further configured to
receive, via the current sensor, a signal indicative of the current;
determine, based on the signal, a current drawn by the first circuit;
determine whether the current drawn is less than a current threshold; and
in response to determining that the current drawn is less than the current threshold, supply power to the first circuit and the second circuit.

8. A thermostat comprising:
a temperature sensor configured to sense a temperature of a surrounding environment;
a first electrical outlet configured to connect to an electric vehicle;
a second electrical outlet configured to connect to an electric heater;
a first circuit in communication with the first electrical outlet;
a second circuit in communication with the second electrical outlet;
an electronic controller in communication with the temperature sensor, the first circuit, and the second circuit, the electronic controller configured to:
receive, via the temperature sensor, a signal;
determine, based on the signal, a temperature value;
determine whether the temperature value is greater than a temperature threshold;
in response to determining that the temperature value is greater than the temperature threshold:
supply power to the first circuit;
control the first circuit to supply a charging current to the first electrical outlet;
in response to determining that the temperature value is less than the temperature threshold:
supply power to the second circuit; and
control the second circuit to supply power to the second electrical outlet.

9. The thermostat of claim 8, wherein the electronic controller is configured to:
determine whether the first device is charged; and
stop supplying power to the first circuit in response to determining that the first device is charged.

10. The thermostat of claim 8, wherein the electronic controller is configured to:
determine a runtime of the second device;
determine whether the runtime of the second device is greater than a runtime threshold; and
stop supplying power to the second circuit in response to determining that the runtime is greater than the runtime threshold.

11. The thermostat of claim 8, further comprising:
a plug in communication with a power source, the plug configured to receive operational power from the power source.

12. The thermostat of claim 8, further comprising:
a display configured to provide an indication of the temperature value; and
a user interface configured to receive a plurality of user inputs.

13. The thermostat of claim 12, wherein the electronic controller is configured to:
receive a first user input via the user interface; and
determine the temperature threshold based on the first user input.

14. The thermostat of claim 8, wherein the first electrical outlet connects to the electric vehicle via a first cord.

15. The thermostat of claim 14, wherein the second electrical outlet connects to the electric heater via a second cord, the second cord different than the first cord.

16. The thermostat of claim 8, further comprising:
a current sensor configured to sense a current of the first circuit; and
wherein the electronic controller is further configured to
receive, via the current sensor, a signal indicative of the current;
determine, based on the signal, a current drawn by the first circuit;
determine whether the current drawn is less than a current threshold; and
in response to determining that the current drawn is less than the current threshold, supply power to the first circuit and the second circuit.

17. A method for switching between charging an electric vehicle and heating a space, the method comprising:
receiving, via an electronic controller, a signal from a temperature sensor;
determining, via the electronic controller, a temperature value based on the signal;
determining, via the electronic controller, whether the temperature value is greater than a temperature threshold;
in response to determining that the temperature value is greater than the temperature threshold:
supplying power to the first circuit;
controlling the first circuit to supply a charging current to the electric vehicle via a first electrical outlet;
in response to determining that the temperature value is less than the temperature threshold:
supplying power to the second circuit; and
controlling the second circuit to supply power to the electric heater via a second electrical outlet.

18. The method of claim 17, the method comprising:
determining, via the electronic controller, whether the first device is charged; and
stopping, via the electronic controller, supply of power to the first circuit in response to determining that the first device is charged.

19. The method of claim 17, the method comprising:
determining, via the electronic controller, a runtime of the second device;
determining, via the electronic controller, whether the runtime of the second device is greater than a runtime threshold; and
stopping, via the electronic controller, supply of power to the second circuit in response to determining that the runtime is greater than the runtime threshold.

20. The method of claim 17, the method comprising:
connecting a plug to a power source; and
receiving, via the electronic controller, operational power from the plug.

21. The method of claim 17, wherein the first electrical outlet connects to the electric vehicle via a first cord.

22. The method of claim 21, wherein the second electrical outlet connects to the electric heater via a second cord, the second cord different than the first cord.

23. The method of claim 16, the method comprising:
receiving, via the electronic controller, a signal indicative of a current of the first circuit from a current sensor;
determining, via the electronic controller, a current drawn by the first circuit based on the signal;
determining, via the electronic controller, whether the current drawn is less than a current threshold; and
in response to determining that the current drawn is less than the current threshold, supplying power to the first circuit and the second circuit.

24. A system for charging an electric vehicle and heating a space, the system comprising:
an electric heater configured to heat the space; and
a thermostat configured to be secured to a wall of the space, the thermostat including
a temperature sensor configured to sense a temperature of a surrounding environment;
a first electrical cord configured to connect to the electric vehicle;
a second electrical cord configured to connect to the electric heater;
a first circuit in communication with the first electrical cord;
a second circuit in communication with the second electrical cord;
an electronic controller in communication with the temperature sensor, the first circuit, and the second circuit, the electronic controller configured to:
receive, via the temperature sensor, a signal;
determine, based on the signal, a temperature value;
determine whether the temperature value is greater than a temperature threshold;
in response to determining that the temperature value is greater than the temperature threshold:
supply power to the first circuit;
control the first circuit to supply a charging current to the electric vehicle via the first electrical cord;
in response to determining that the temperature value is less than the temperature threshold:
supply power to the second circuit; and
control the second circuit to supply power to the electric heater via the second electrical cord.

25. The system of claim 24, wherein the electronic controller is configured to:
determine whether the electric vehicle is charged; and
stop supplying power to the first circuit in response to determining that the electric vehicle is charged.

26. The system of claim 24, wherein the electronic controller is configured to:
determine a runtime of the electric heater;
determine whether the runtime of the electric heater is greater than a runtime threshold; and
stop supplying power to the second circuit in response to determining that the runtime is greater than the runtime threshold.

27. The system of claim 24, wherein the thermostat is directly wired to a power source within the space, the thermostat configured to receive operational power from the power source.

28. The system of claim 24, wherein the thermostat further includes:
a current sensor configured to sense a current of the first circuit; and
wherein the electronic controller is further configured to
receive, via the current sensor, a signal indicative of the current;
determine, based on the signal, a current drawn by the first circuit;
determine whether the current drawn is less than a current threshold; and
in response to determining that the current drawn is less than the current threshold, supply power to the first circuit and the second circuit.
